(19) United States
(12) Patent Application Publication
(10) Pub. No.: US 2025/0207004 A1
(43) Pub. Date: Jun. 26, 2025

(54) TWO-COMPONENT POLYURETHANE ADHESIVE COMPOSITION

(71) Applicant: DuPont Technology (Shanghai) Co., Ltd., Shanghai (CN)

(72) Inventor: Zhenghe ZHANG, Shanghai (CN)

(21) Appl. No.: 18/849,118

(22) PCT Filed: May 12, 2022
(86) PCT No.: PCT/CN2022/092363

§ 371 Date: Sep. 20, 2024

(51) Int. Cl. C09J 175/04; C08G 18/10; C08G 18/48; C09J 5/00; C09J 9/00

(52) U.S. Cl. CPC C09J 175/04; C08G 18/10; C08G 18/4816; C09J 5/00; C09J 9/00; C08G 2170/00; C09J 2475/00

(57) ABSTRACT

Provided herein is a two-component polyurethane adhesive composition.

### FIELD OF INVENTION

The present invention relates to the field of two-component polyurethane adhesive compositions.

### BACKGROUND OF THE INVENTION

Two-component polyurethane adhesives provide versatile attachment means. In the automotive industry, their use is increasing, driven partly by the desire to reduce weight attributed to conventional attachment means, such as rivets.

Two-component polyurethanes comprise an isocyanate component and a polyol component. The isocyanate component comprises at least one isocyanate-terminated molecule, and the polyol component comprises at least one polyol. Immediately prior to use, the two components are mixed, and the polyol OH groups react with the NCO groups of the isocyanate-terminated molecule, resulting in the formation of higher molecular weight polyurethanes which may be linear or branched (i.e. cross-linked). Once the components are mixed, and molecular weights begin to increase, viscosity of the mixture also increases. There is a limited time in which the adhesive mixture has a viscosity that permits manipulation of the adhesive mixture and of parts that are adhered using the mixture. The time from mixing to a defined degree of cure (and/or viscosity) is called “working time”. For some applications, it is desirable to have a prolonged working time.

### SUMMARY OF THE INVENTION

In a first aspect, the invention provides a two-component thermally-conductive polyurethane adhesive, comprising:
(A) Component A:
(ai) an NCO-terminated prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI;
(B) Component B:
(bi) at least one polyol of molecular weight (Mₙ) of less than 1,000 Da and an OH functionality of at least 2; and
(bii) optionally a catalyst capable of catalyzing the reaction of OH groups with NCO groups.

In a second aspect, the invention provides a kit for producing a thermally-conductive polyurethane adhesive, comprising:
(A) Component A:
(ai) an NCO-terminated prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI;
(B) Component B:
(bi) at least one polyol of molecular weight (Mₙ) of less than 1,000 Da and an OH functionality of at least 2; and
(bii) optionally a catalyst capable of catalyzing the reaction of OH groups with NCO groups.

In a third aspect, the invention provides a method for adhering two or more substrates, comprising the steps:
(1) providing an adhesive comprising:
(A) Component A:
(ai) an NCO-terminated prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI;
(B) Component B:
(bi) at least one polyol of molecular weight (Mₙ) of less than 1,000 Da and an OH functionality of at least 2; and
(bii) optionally a catalyst capable of catalyzing the reaction of OH groups with NCO groups;
(2) mixing Component A and Component B to produce an adhesive mixture;
(3) applying the adhesive mixture to a first substrate;
(4) bringing the first substrate into adhesive contact with a second substrate;
(5) allowing the adhesive mixture to cure.

In a fourth aspect, the invention provides an adhered assembly, comprising:
(1) a first substrate;
(2) a second substrate adhered to the first substrate;
wherein the first substrate and the second substrate are adhered one to the other by an adhesive made by mixing together the following Component A and Component B:
(A) Component A:
(ai) an NCO-terminated prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI;
(B) Component B:
(bi) at least one polyol of molecular weight (Mₙ) of less than 1,000 Da and an OH functionality of at least 2; and
(bii) optionally a catalyst capable of catalyzing the reaction of OH groups with NCO groups.

### DETAILED DESCRIPTION OF THE INVENTION

The inventors have found that it is possible to achieve prolonged working times and slow development of viscosity in a polyurethane adhesive by using an isocyanate component (Component A) that comprises a prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI, and by using a polyol component that comprises at least one polyol of molecular weight (Mₙ) of less than 1,000 Da and an OH functionality of at least 2.

### Definitions and Abbreviations

MDI Methylene-bis-(phenyl isocyanate)
HDI Hexamethylene diisocyanate
IPDI isophorone diisocyanate
PU polyurethane
GPC gel permeation chromatography
RH relative humidity

Equivalent and molecular weights are measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscothek TDA (integrated refractive index viscometer and light scattering) was used as a detector.

### Component a (Isocyanate)

Component A comprises an NCO-terminated prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI.

The polyol is preferably selected from polyether polyols, in particular poly(C₂₋₄-alkylene oxide) polyols.

In a preferred embodiment, the polyol is selected from poly(propylene oxide) polyols.

The polyol used to make the prepolymer preferably has a functionality of 2.5-3, more preferably 3.

In a preferred embodiment, the polyol used to make the prepolymer is a polyether polyol having a functionality of 2.5-3, more preferably 3.

In a more preferred embodiment, the polyol used to make the prepolymer is a poly(C₂₋₄-alkylene oxide) polyol having a functionality of 2.5-3, more preferably 3.

In another preferred embodiment, the polyol used to make the prepolymer is a poly(propylene oxide) polyol having a functionality of 2.5-3, more preferably 3.

In another preferred embodiment, the polyol used to make the prepolymer has a molecular weight (Mₙ) greater than 2,500 Da, more preferably it has a molecular weight (Mₙ) of 3,000 Da.

In a preferred embodiment, the polyol used to make the prepolymer is selected from polyether polyols, in particular poly(C₂₋₄-alkylene oxide) polyols, having a molecular weight (Mₙ) greater than 2,500 Da, more preferably it has a molecular weight (Mₙ) of 3,000 Da.

In a preferred embodiment, the polyol is selected from poly(propylene oxide) polyols, having a molecular weight (Mₙ) greater than 2,500 Da, more preferably it has a molecular weight (Mₙ) of 3,000 Da.

The polyol used to make the prepolymer preferably has a functionality of 2.5-3, more preferably 3, and has a molecular weight (Mₙ) greater than 2,500 Da, more preferably it has a molecular weight (Mₙ) of 3,000 Da.

In a preferred embodiment, the polyol used to make the prepolymer is a polyether polyol having a functionality of 2.5-3, more preferably 3, having a molecular weight (Mₙ) greater than 2,500 Da, more preferably it has a molecular weight (Mₙ) of 3,000 Da.

In a more preferred embodiment, the polyol used to make the prepolymer is a poly(C₂₋₄-alkylene oxide) polyol having a functionality of 2.5-3, more preferably 3, having a molecular weight (Mₙ) greater than 2,500 Da, more preferably it has a molecular weight (Mₙ) of 3,000 Da.

In another preferred embodiment, the polyol used to make the prepolymer is a poly(propylene oxide) polyol having a functionality of 2.5-3, more preferably 3, having a molecular weight (Mₙ) greater than 2,500 Da, more preferably it has a molecular weight (Mₙ) of 3,000 Da.

The prepolymer may be made with a mixture of polyols selected from those described herein.

The polyisocyanate is selected from aliphatic polyisocyanates and mixtures of 2,4′-MDI and 4,4′-MDI.

In a preferred embodiment, the polyisocyanate is aliphatic, with isophorone diisocyanate (IPDI), Dicyclohexyl methane diisocyanate (HMDI), and hexamethylene diisocyanate (HDI), and mixtures of these being particularly preferred.

In another preferred embodiment, the polyisocyanate is a mixture of 2,4′-MDI and 4,4′-MDI. More preferably the weight ratio of 2,4′-MDI to 4,4′-MDI is 0.667-1.5, more particularly preferably 0.8-1.5, even more particularly preferably 1-1.5.

Particularly preferred is a mixture of 2,4′-MDI and 4,4-MDI, with a 1:1 weight ratio of 2,4′-MDI and 4,4-MDI.

The NCO-terminated prepolymer of Component A is made by reacting the at least one polyol with the at least one polyisocyanate. This reaction is preferably carried out under dry and inert conditions, in particular under vacuum. In a preferred embodiment, the at least one polyol is first dried under vacuum and elevated temperature (>100° C.), and cooled (e.g. to 80° C.) before the at least one polyisocyanate is added under vacuum. The mixture is allowed to react under vacuum for 1-2 hours. The prepolymer may be purified, however, preferably the resulting reaction mixture and is used without purification.

The at least one polyisocyanate is used in an amount such that there is an excess of NCO groups with respect to the polyol OH groups. In a preferred embodiment, the at least one polyisocyanate is used in a stoichiometric excess of 2-15-fold with respect to the polyol, more preferably 8-12-fold with respect to the polyol, particularly preferably 10-fold with respect to the polyol.

In a preferred embodiment, the prepolymer is made by reacting a polyether polyol with a mixture of 2,4′-MDI and 4,4′-MDI.

In another preferred embodiment, the prepolymer is made by reacting a poly(C₂₋₄alkylene oxide) polyol with a mixture of 2,4′-MDI and 4,4′-MDI.

In another preferred embodiment, the prepolymer is made by reacting a poly(propylene oxide) polyol with a mixture of 2,4′-MDI and 4,4′-MDI.

In another preferred embodiment, the prepolymer is made by reacting a polyether polyol having a functionality of 2.5-3, more preferably 3, with a mixture of 2,4′-MDI and 4,4′-MDI.

In another preferred embodiment, the prepolymer is made by reacting a poly(C₂₋₄-alkylene oxide) polyol having a functionality of 2.5-3, more preferably 3, with a mixture of 2,4′-MDI and 4,4′-MDI.

In another preferred embodiment, the prepolymer is made by reacting a poly(propylene oxide) polyol having a functionality of 2.5-3, more preferably 3, with a mixture of 2,4′-MDI and 4,4′-MDI.

In another preferred embodiment, the prepolymer is made by reacting a polyether polyol having a molecular weight (Mₙ) of greater than 2,500 Da, more preferably a molecular weight (Mₙ) of 3,000 Da, with a mixture of 2,4′-MDI and 4,4′-MDI.

In another preferred embodiment, the prepolymer is made by reacting a poly(C₂₋₄-alkylene oxide) polyol having a molecular weight (Mₙ) of greater than 2,500 Da, more preferably a molecular weight (Mₙ) of 3,000 Da, with a mixture of 2,4′-MDI and 4,4′-MDI.

In another preferred embodiment, the prepolymer is made by reacting a poly(propylene oxide) polyol having a molecular weight (Mₙ) of greater than 2,500 Da, more preferably a molecular weight (Mₙ) of 3,000 Da, with a mixture of 2,4′-MDI and 4,4′-MDI.

In another preferred embodiment, the prepolymer is made by reacting a polyether polyol having a molecular weight (Mₙ) of greater than 2,500 Da, more preferably a molecular weight (Mₙ) of 3,000 Da, and a functionality of 2.5-3, preferably 3, with a mixture of 2,4′-MDI and 4,4′-MDI.

In another preferred embodiment, the prepolymer is made by reacting a polyether polyol having a molecular weight (Mₙ) of greater than 2,500 Da, more preferably a molecular weight (Mₙ) of 3,000 Da, and a functionality of 2.5-3, preferably 3, with a mixture of 2,4′-MDI and 4,4′-MDI.

In another preferred embodiment, the prepolymer is made by reacting a poly(C₂₋₄-alkylene oxide) polyol having a molecular weight (Mₙ) of greater than 2,500 Da, more preferably a molecular weight (Mₙ) of 3,000 Da, and a functionality of 2.5-3, preferably 3, with a mixture of 2,4′-MDI and 4,4′-MDI.

In another preferred embodiment, the prepolymer is made by reacting a poly(propylene oxide) polyol having a molecular weight (Mₙ) of greater than 2,500 Da, more preferably a molecular weight (Mₙ) of 3,000 Da, and a functionality of 2.5-3, preferably 3, with a mixture of 2,4′-MDI and 4,4′-MDI.

In another preferred embodiment, the prepolymer is made by reacting a polyether polyol having a molecular weight (Mₙ) of greater than 2,500 Da, more preferably a molecular weight (Mₙ) of 3,000 Da, and a functionality of 2.5-3, preferably 3, with a mixture of 2,4′-MDI and 4,4′-MDI.

In a particularly preferred embodiment, the prepolymer is made by reacting a poly(propylene oxide) polyol of molecular weight (Mₙ) of 3,000 Da and functionality of 3 with a 1:1 (wt:wt) mixture of 2,4′-MDI and 4,4′-MDI.

The at least one polyol is preferably used in Component A at 10-40 wt %, more preferably 25-35 wt %, particularly preferably 28-29 wt %, based on the total weight of Component A, it being understood that the polyol is in the form of prepolymer.

The at least one polyisocyanate is used in Component A at 20-50 wt %, more preferably 30-40 wt %, more particular preferably 34-36 wt %, based on the total weight of Component A.

The NCO-terminated prepolymer preferably comprises 40-50 wt % polyol, more preferably 42-48 wt %, particularly preferably 43-45 wt %, based on the total weight of the prepolymer.

The NCO-terminated prepolymer preferably comprises 50-60 wt % diisocyanate, more preferably 52-58 wt %, particularly preferably 54-56 wt %, based on the total weight of the prepolymer.

The prepolymer is preferably used without purification. The prepolymer mixture preferably is used in Component A at 50-75 wt %, more preferably 55-70 wt %, more particularly preferably 60-66 wt %, based on the total weight of Component A.

Component A may additionally comprise talc. If used, talc is preferably present at 25-40 wt %, more preferably 30-40 wt %, particularly preferably 32-37 wt %, based on the total weight of Component A.

Component A may additionally comprise fumed silica. If used, fumed silica is preferably present at 0.75-2 wt %, more preferably 1-2 wt %, based on the total weight of Component A.

Component A is typically formulated by drying the solid ingredients, such as talc and fumed silica at elevated temperature under vacuum. Preferably drying is carried out until the moisture content is 300 ppm or less. The prepolymer is added to the dry ingredients and mixed to homogeneity under reduced pressure, and Component A is then stored in a moisture-proof container.

### Component B (Polyol)

Component B comprises (bi) at least one polyol of molecular weight (Mₙ) less than 1,000 Da and an OH functionality of at least 2; and (bii) optionally a catalyst capable of catalyzing the reaction of OH groups with NCO groups.

The at least one polyol preferably comprises polyols having molecular weights (Mn) greater than 400 Da. Preferably the at least one polyol comprises polyols having molecular weights (Mn) of 400-1,000 Da, more preferably 500-1,000 Da.

In a preferred embodiment, the at least one polyol comprises polyols having a functionality of 3 or more.

In a more preferred embodiment, the at least one polyol comprises polyols having a functionality of 3 or more, and having molecular weights (Mn) of 400-1,000 Da, more preferably 500-1,000 Da.

In a more preferred embodiment, the at least one polyol comprises a mixture polyols, particularly a mixture of a polyol having a functionality of 3 with a polyol having a functionality of greater than 3.

In a preferred embodiment, the at least one polyol comprises a polyether polyol. Preferred polyether polyols are selected from poly(C₂₋₄-alkylene oxide)-based polyols, particularly poly(ethylene oxide)-based, poly(propylene oxide)-based, poly(butylene oxide)-based polyols, and mixtures of these. In a particularly preferred embodiment the polyether polyol is selected from poly(propylene oxide)-based polyols.

In another preferred embodiment, the at least one polyol comprises a triol. The triol may be, for example, poly(C₂₋₄-alkylene oxide)-based, in particular poly(propylene oxide)-based, or it may be, for example, castor oil. In a particularly preferred embodiment, the triol is castor oil.

In a preferred embodiment, the at least one polyol comprises a mixture of a polyether polyol and castor oil, in particular a mixture of polyether polyol having functionality of greater than 3, more preferably greater than 4, particularly preferably greater than 5, and castor oil.

In a preferred embodiment, the polyether polyol having a functionality of greater than 3, more preferably greater than 4, particularly preferably greater than 5, is a poly(propylene oxide) polyol.

In a preferred embodiment, Component B comprises 40-60 wt % of a triol, based on the total weight of Component B.

In a preferred embodiment, Component B comprises 0-10 wt % of a polyol having functionality of greater than 3, more preferably greater than 4.

In a preferred embodiment, Component B comprises 0-20 wt % of a polyol having functionality greater than 2, more preferably a functionality of 3, and a molecular weight of less than 500 Da, more preferably less than 400 Da.

In another preferred embodiment, Component B comprises 40-60 wt % of a triol, based on the total weight of Component B, 0-10 wt % of a polyol having functionality of greater than 3, more preferably greater than 4, and 0-20 wt % of a polyol having functionality greater than 2, more preferably a functionality of 3, and a molecular weight of less than 500 Da, more preferably less than 400 Da.

In another preferred embodiment, the at least one polyol comprises a mixture of 80-97 wt %, more preferably 85-95 wt %, particularly preferably 91-94 wt % of castor oil, with 3-20 wt %, more preferably 5-15 wt %, particularly preferably 6-9 wt %, of a polyether polyol, in particular a polyether polyol having functionality of greater than 3, more preferably greater than 4, particularly preferably greater than 5, wherein the wt %'s are based on the total weight of polyols in Component B.

In another preferred embodiment, the at least one polyol comprises a mixture of 80-97 wt %, more preferably 85-95 wt %, particularly preferably 91-94 wt % of a triol, with 3-20 wt %, more preferably 5-15 wt %, particularly preferably 6-9 wt %, based on the total weight of polyols in Component B, of a polyether polyol having functionality of greater than 3, more preferably greater than 4, particularly preferably greater than 5.

In a particularly preferred embodiment, the at least one polyol comprises a mixture of a poly(propylene oxide) having a functionality of 6 with castor oil.

In another particularly preferred embodiment, the at least one polyol comprises a mixture of 80-97 wt %, more preferably 85-95 wt %, particularly preferably 91-94 wt % of castor oil, with 3-20 wt %, more preferably 5-15 wt %, particularly preferably 6-9 wt %, of a poly(propylene oxide) polyol having functionality of 6, wherein the wt %'s are based on the total weight of polyols in Component B.

Component B additionally optionally comprises a catalyst that is capable of catalyzing the reaction of isocyanate groups with OH groups.

Examples of such catalysts include tertiary amine catalysts, organometallic catalysts, such as bismuth catalysts, alkyl tin carboxylates, oxides and tin mercaptides.

Specific examples of tertiary amine catalysts include N-methyl morpholine, N-methyl imidazole, triethylenediamine, bis-(2-dimethylaminoethyl)-ether, 1,4-diazabicyclo[2.2.2]octane (DABCO), dimethylcyclohexylamine, dimethylethanolamine, 2,2-dimorpholinyl-diethylether (DMDEE), N,N,N-dimethylaminopropyl hexahydrotriazine, dimethyltetrahydropyrimidine, tetramethylethylenediamine, dimethylcyclohexylamine, 2,2-N,N benzyldimethylamine, dimethylethanol amine, dimethylaminopropyl amine, Penta-dimethyl diethylene triamine, N,N,N′,N′-tetramethyl-1,6-hexanediamine, N,N′,N′-trimethylaminoethylpiperazine, 1,1′-[[3-(dimethylamino) propyl]imino]bispropan-2-ol, 1,3,5-tris[3-(dimethylamino) propyl]hexahydro-1,3,5-triazine, N—N-dimethyldipropylene triamine, N,N,N′-trimethylaminoethylethanolamine, with DMDEE being particularly preferred.

If an organometallic catalyst is used, it is any organometallic catalyst capable of catalyzing the reaction of isocyanate with a functional group having at least one reactive hydrogen. Examples include bismuth catalysts, metal carboxylates such as tin carboxylate and zinc carboxylate. Metal alkanoates include stannous octoate, bismuth octoate or bismuth neodecanoate. Preferably the at least one organometallic catalyst is a bismuth catalyst or an organotin catalyst. Examples include dibutyltin dilaurate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate. In a preferred embodiment, the catalyst is a tin catalyst, particularly preferably dioctyltin mercaptide, and/or dimethyltin dithioglycolate. In a particularly preferred embodiment, the catalyst is dioctyltin mercaptide.

The catalyst is preferably used at 0.0005 to 0.002 wt %, more preferably 0.00075 to 0.0015 wt %, based on the total weight of Component B.

In a preferred embodiment, the catalyst is dioctyl tin mercaptide, used at 0.0005 to 0.002 wt %, more preferably 0.00075 to 0.0015 wt %, based on the total weight of Component B.

Component B may additionally comprise talc. If used, talc is preferably present at 20-50 wt %, more preferably 30-40 wt %, particularly preferably 30-34 wt %, based on the total weight of Component B.

Component B may additionally comprise fumed silica. If used, fumed silica is preferably present at 0.75-2 wt %, more preferably 1-2 wt %, based on the total weight of Component A.

Component B may additionally comprise a water scavenger, such as molecular sieves. If used, molecular sieves are preferably used at 1-5 wt %, more preferably 2-4 wt %, based on the total weight of Component B.

Component B is typically formulated by drying the solid ingredients, such as talc and fumed silica at elevated temperature under vacuum. Preferably drying is carried out until the moisture content is 300 ppm or less. The at least one polyol and catalyst, are added to the dry ingredients and mixed to homogeneity under reduced pressure, and Component B is then stored in a moisture-proof container.

### Method of Manufacture

The adhesive compositions of the invention are made by mixing the ingredients of each Component separately, preferably under inert and dry conditions and/or under vacuum, until a homogenous mixture is obtained. Once the Components are prepared, they are stored in separate containers until use.

### Method of Use

In one aspect, the invention provides a method for adhering two or more substrates, comprising the steps:
(1) providing an adhesive comprising:
(A) Component A:
(ai) an NCO-terminated prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI;
(B) Component B:
(bi) at least one polyol of molecular weight (Mₙ) of less than 1,000 Da and an OH functionality of at least 2; and
(bii) optionally a catalyst capable of catalyzing the reaction of OH groups with NCO groups;
(2) mixing Component A and Component B to produce an adhesive mixture;
(3) applying the adhesive mixture to a first substrate;
(4) bringing the first substrate into adhesive contact with a second substrate;
(5) allowing the adhesive mixture to cure.

The ingredients for Components A and B, useful for the method of the invention, are as described for the adhesive.

Mixing of Component A and Component B is carried out by any method that can achieve a homogenous mixture fairly quickly. Typically, mixing is achieved by dispensing both components simultaneously into a mixing container or passage. Mixing of Component A and Component B may be in any desired proportion, but is typically done using a volumetric ratio A:B of 0.8-1.2, more preferably 1.

Applying the adhesive mixture to a substrate is typically performed using a suitable application gun and a static mixer. The adhesive is filled in cartridges which can ensure the suitable mixing ratio. The cartridges are placed in the application gun and a suitable static mixer is mounted. Then the adhesive is pressed through the static mixer on to the surface to be bonded.

Curing is typically done at ambient temperature (e.g. 23° C.), and humidity (e.g. 50% relative humidity). Full cure with the adhesives of the invention usually develops in 7-10 days.

The substrates are not particularly limited, and include metals and plastics. The adhesives of the invention are particularly suited for adhering e-coated steel, PET films, Aluminized plastic films, Aluminium.

Preferred applications include thermal conductive material, used in any application where a thermal conductive material is needed, with main application in automotive industry for the thermal management of the EV battery; especially for the bonding of the modules or cell to cooling plate.

### Effect of the Invention

The cured adhesives of the invention (7 days, 23° C., 50% RH) preferably show a lap shear strength of 4 MPa or greater, when measured according to DIN EN 1465, with a bonded area: 250 mm² (10×25 mm), adhesive layer thickness of 1 mm, using e-coated steel for both substrates.

The adhesive mixture resulting from mixing Component A and Component B (preferably in a 0.8:1 to 1.2:1, more preferably 1:1 volumetric ratio) preferably has a working time of greater than 60 minutes, more preferably greater than 65 minutes. Working time is the time for rheological viscosity to reach 900 Pas at 0.25/s shear rate, 500 Pas at 1/s shear rate, and 300 Pas at 2.5/s shear rate, concurrently. Rheologic viscosity is measured using a TA Rheometer, with 25 mm parallel plates and a 0.2 mm gap.

The adhesive mixture resulting from mixing Component A and Component B (preferably in a 0.8:1 to 1.2:1, more preferably 1:1 volumetric ratio) preferably has a tensile strength of 5 MPa or less, after curing for seven days at 23° C. and 50% RH, when measured according to DIN EN ISO 527-2, and pulling the samples at 50 mm/min.

The adhesive mixture resulting from mixing Component A and Component B (preferably in a 0.8:1 to 1.2:1, more preferably 1:1 volumetric ratio) preferably has an E-modulus of 15 or less, after curing for seven days at 23° C. and 50% RH, when measured according to DIN EN ISO 527-2, and pulling the samples at 50 mm/min.

The adhesive mixture resulting from mixing Component A and Component B (preferably in a 0.8:1 to 1.2:1, more preferably 1:1 volumetric ratio) preferably has an elongation at break of 100% or more, after curing for seven days at 23° C. and 50% RH, when measured according to DIN EN ISO 527-2, and pulling the samples at 50 mm/min.

### Particularly Preferred Embodiments

The following are particularly preferred embodiments of the adhesive compositions of the invention:
1. A two-component thermally-conductive polyurethane adhesive, comprising:
   (A) Component A:
   (ai) an NCO-terminated prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI;
   (B) Component B:
   (bi) at least one polyol of molecular weight (Mₙ) of less than 1,000 Da and an OH functionality of at least 2; and
   (bii) optionally a catalyst capable of catalyzing the reaction of OH groups with NCO groups.
2. A kit for producing a thermally-conductive polyurethane adhesive, comprising:
   (A) Component A:
   (ai) an NCO-terminated prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI;
   (B) Component B:
   (bi) at least one polyol of molecular weight (Mₙ) of less than 1,000 Da and an OH functionality of at least 2; and
   (bii) optionally a catalyst capable of catalyzing the reaction of OH groups with NCO groups.
3. A method for adhering two or more substrates, comprising the steps: (1) providing an adhesive comprising:
   (A) Component A:
   (ai) an NCO-terminated prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI;
   (B) Component B:
   (bi) at least one polyol of molecular weight (Mₙ) of less than 1,000 Da and an OH functionality of at least 2; and
   (bii) optionally a catalyst capable of catalyzing the reaction of OH groups with NCO groups;
   (2) mixing Component A and Component B to produce an adhesive mixture;
   (3) applying the adhesive mixture to a first substrate;
   (4) bringing the first substrate into adhesive contact with a second substrate;
   (5) allowing the adhesive mixture to cure.
4. An adhered assembly, comprising:
   (1) a first substrate;
   (2) a second substrate adhered to the first substrate;
   wherein the first substrate and the second substrate are adhered one to the other by an adhesive made by mixing together the following Component A and Component B:
   (A) Component A:
   (ai) an NCO-terminated prepolymer made by reacting at least one polyol of molecular weight (Mₙ) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI;
   (B) Component B:
   (bi) at least one polyol of molecular weight (Mₙ) of less than 1,000 Da and an OH functionality of at least 2; and
   (bii) optionally a catalyst capable of catalyzing the reaction of OH groups with NCO groups.
5. Any one preceding embodiment, wherein the polyol used to make the prepolymer is selected from polyether polyols, in particular poly(C₂₋₄-alkylene oxide) polyols.
6, Any one preceding embodiment, wherein the polyol used to make the prepolymer is selected from poly(propylene oxide) polyols.
7. Any one preceding embodiment, wherein the polyol used to make the prepolymer has a functionality of 2.5-3, more preferably 3.
8. Any one preceding embodiment, wherein the polyol used to make the prepolymer is a polyether polyol having a functionality of 2.5-3, more preferably 3.
9. Any one preceding embodiment, wherein the polyol used to make the prepolymer is a poly(C₂₋₄-alkylene oxide) polyol having a functionality of 2.5-3, more preferably 3.
10. Any one preceding embodiment, wherein the polyol used to make the prepolymer is a poly(propylene oxide) polyol having a functionality of 2.5-3, more preferably 3.
11. Any one preceding embodiment, wherein the polyol used to make the prepolymer has a molecular weight (Mₙ) greater than 2,500 Da, more preferably it has a molecular weight (Mₙ) of 3,000 Da.
12. Any one preceding embodiment, wherein the polyol used to make the prepolymer is selected from polyether polyols, in particular poly(C₂₋₄-alkylene oxide) polyols, having a molecular weight (Mₙ) greater than 2,500 Da, more preferably it has a molecular weight (Mₙ) of 3,000 Da.
13. Any one preceding embodiment, wherein the polyol used to make the prepolymer is selected from poly(propylene oxide) polyols, having a molecular weight (Mₙ) greater than 2,500 Da, more preferably it has a molecular weight (Mₙ) of 3,000 Da.
14. Any one preceding embodiment, wherein the polyol used to make the prepolymer has a functionality of 2.5-3, more preferably 3, and has a molecular weight (Mₙ) greater than 2,500 Da, more preferably it has a molecular weight (Mₙ) of 3,000 Da.
15. Any one preceding embodiment, wherein the polyol used to make the prepolymer is a polyether polyol having a functionality of 2.5-3, more preferably 3, having a molecular weight (Mₙ) greater than 2,500 Da, more preferably it has a molecular weight (Mₙ) of 3,000 Da.
16. Any one preceding embodiment, wherein the polyol used to make the prepolymer is a poly(C₂₋₄-alkylene oxide) polyol having a functionality of 2.5-3, more preferably 3, having a molecular weight (Mₙ) greater than 2,500 Da, more preferably it has a molecular weight (Mₙ) of 3,000 Da.
17. Any one preceding embodiment, wherein the polyol used to make the prepolymer is a poly(propylene oxide) polyol having a functionality of 2.5-3, more preferably 3, having a molecular weight (Mₙ) greater than 2,500 Da, more preferably it has a molecular weight (Mₙ) of 3,000 Da.
18. Any one preceding embodiment, wherein the prepolymer is made with a mixture of polyols selected from those described herein.
19. Any one preceding embodiment, wherein the polyisocyanate is selected from aliphatic polyisocyanates and mixtures of 2,4′-MDI and 4,4′-MDI.
20. Any one preceding embodiment, wherein the polyisocyanate is aliphatic, with isophorone diisocyanate (IPDI), Dicyclohexyl methane diisocyanate (HMDI), and hexamethylene diisocyanate (HDI), and mixtures of these being particularly preferred.
21. Any one preceding embodiment, wherein the polyisocyanate is a mixture of 2,4′-MDI and 4,4′-MDI.
22. Any one preceding embodiment, wherein the polyisocyanate is a mixture of 2,4′-MDI and 4,4′-MDI, and the weight ratio of 2,4′-MDI to 4,4′-MDI is 0.667-1.5, more particularly preferably 0.8-1.5, even more particularly preferably 1-1.5.
23. Any one preceding embodiment, wherein the polyisocyanate is a mixture of 2,4′-MDI and 4,4-MDI, with a 1:1 weight ratio of 2,4′-MDI and 4,4-MDI.
24. Any one preceding embodiment, wherein the prepolymer reaction mixture and is used without purification.
25. Any one preceding embodiment, wherein the at least one polyisocyanate is used in an amount such that there is a stoichiometric excess of 2-15-fold with respect to the polyol, more preferably 8-12-fold with respect to the polyol, particularly preferably 10-fold with respect to the polyol.
26. Any one preceding embodiment, wherein the prepolymer is made by reacting a polyether polyol with a mixture of 2,4′-MDI and 4,4′-MDI.
27. Any one preceding embodiment, wherein the prepolymer is made by reacting a poly(C₂₋₄alkylene oxide) polyol with a mixture of 2,4′-MDI and 4,4′-MDI.
28. Any one preceding embodiment, wherein the prepolymer is made by reacting a poly(propylene oxide) polyol with a mixture of 2,4′-MDI and 4,4′-MDI.
29. Any one preceding embodiment, wherein the prepolymer is made by reacting a polyether polyol having a functionality of 2.5-3, more preferably 3, with a mixture of 2,4′-MDI and 4,4′-MDI.
30. Any one preceding embodiment, wherein the prepolymer is made by reacting a poly(C₂₋₄-alkylene oxide) polyol having a functionality of 2.5-3, more preferably 3, with a mixture of 2,4′-MDI and 4,4′-MDI.
31. Any one preceding embodiment, wherein the prepolymer is made by reacting a poly(propylene oxide) polyol having a functionality of 2.5-3, more preferably 3, with a mixture of 2,4′-MDI and 4,4′-MDI.
32. Any one preceding embodiment, wherein the prepolymer is made by reacting a polyether polyol having a molecular weight (Mₙ) of greater than 2,500 Da, more preferably a molecular weight (Mₙ) of 3,000 Da, with a mixture of 2,4′-MDI and 4,4′-MDI.
33. Any one preceding embodiment, wherein the prepolymer is made by reacting a poly(C₂₋₄-alkylene oxide) polyol having a molecular weight (Mₙ) of greater than 2,500 Da, more preferably a molecular weight (Mₙ) of 3,000 Da, with a mixture of 2,4′-MDI and 4,4′-MDI.
34. Any one preceding embodiment, wherein the prepolymer is made by reacting a poly(propylene oxide) polyol having a molecular weight (Mₙ) of greater than 2,500 Da, more preferably a molecular weight (Mₙ) of 3,000 Da, with a mixture of 2,4′-MDI and 4,4′-MDI.
35. Any one preceding embodiment, wherein the prepolymer is made by reacting a polyether polyol having a molecular weight (Mₙ) of greater than 2,500 Da, more preferably a molecular weight (Mₙ) of 3,000 Da, and a functionality of 2.5-3, preferably 3, with a mixture of 2,4′-MDI and 4,4′-MDI.
36. Any one preceding embodiment, wherein the prepolymer is made by reacting a polyether polyol having a molecular weight (Mₙ) of greater than 2,500 Da, more preferably a molecular weight (Mₙ) of 3,000 Da, and a functionality of 2.5-3, preferably 3, with a mixture of 2,4′-MDI and 4,4′-MDI.
37. Any one preceding embodiment, wherein the prepolymer is made by reacting a poly(C₂₋₄-alkylene oxide) polyol having a molecular weight (Mₙ) of greater than 2,500 Da, more preferably a molecular weight (Mₙ) of 3,000 Da, and a functionality of 2.5-3, preferably 3, with a mixture of 2,4′-MDI and 4,4′-MDI.
38. Any one preceding embodiment, wherein the prepolymer is made by reacting a poly(propylene oxide) polyol having a molecular weight (Mₙ) of greater than 2,500 Da, more preferably a molecular weight (Mₙ) of 3,000 Da, and a functionality of 2.5-3, preferably 3, with a mixture of 2,4′-MDI and 4,4′-MDI.
39. Any one preceding embodiment, wherein the prepolymer is made by reacting a polyether polyol having a molecular weight (Mₙ) of greater than 2,500 Da, more preferably a molecular weight (Mₙ) of 3,000 Da, and a functionality of 2.5-3, preferably 3, with a mixture of 2,4′-MDI and 4,4′-MDI.
40. Any one preceding embodiment, wherein the prepolymer is made by reacting a poly(propylene oxide) polyol of molecular weight (Mn) of 3,000 Da and functionality of 3 with a 1:1 (wt:wt) mixture of 2,4′-MDI and 4,4′-MDI.
41. Any one preceding embodiment, wherein the at least one polyol is used in Component A at 10-40 wt %, more preferably 25-35 wt %, particularly preferably 28-29 wt %, based on the total weight of Component A.
42. Any one preceding embodiment, wherein the at least one polyisocyanate is used in Component A at 20-50 wt %, more preferably 30-40 wt %, more particular preferably 34-36 wt %, based on the total weight of Component A.
43. Any one preceding embodiment, wherein the NCO-terminated prepolymer preferably comprises 40-50 wt % polyol, more preferably 42-48 wt %, particularly preferably 43-45 wt %, based on the total weight of the prepolymer.
44. Any one preceding embodiment, wherein the NCO-terminated prepolymer preferably comprises 50-60 wt % diisocyanate, more preferably 52-58 wt %, particularly preferably 54-56 wt %, based on the total weight of the prepolymer.
45. Any one preceding embodiment, wherein the prepolymer is used without purification.
46. Any one preceding embodiment, wherein the prepolymer mixture is used in Component A at 50-75 wt %, more preferably 55-70 wt %, more particularly preferably 60-66 wt %, based on the total weight of Component A.
47. Any one preceding embodiment, wherein Component A additionally comprises talc.
48. Any one preceding embodiment, wherein Component A comprises talc at 25-40 wt %, more preferably 30-40 wt %, particularly preferably 32-37 wt %, based on the total weight of Component A.
49. Any one preceding embodiment, wherein the at least one polyol in Component B comprises polyols having molecular weights (Mn) greater than 400 Da.
50. Any one preceding embodiment, wherein the at least one polyol in Component B comprises polyols having molecular weights (Mn) of 400-1,000 Da, more preferably 500-1,000 Da.
51. Any one preceding embodiment, wherein the at least one polyol in Component B comprises polyols having a functionality of 3 or more.
52. Any one preceding embodiment, wherein the at least one polyol in Component B comprises polyols having a functionality of 3 or more, and having molecular weights (Mn) of 400-1,000 Da, more preferably 500-1,000 Da.
53. Any one preceding embodiment, wherein the at least one polyol in Component B comprises a mixture polyols, particularly a mixture of a polyol having a functionality of 3 with a polyol having a functionality of greater than 3.
54. Any one preceding embodiment, wherein the at least one polyol in Component B comprises a polyether polyol.
55. Any one preceding embodiment, wherein the at least one polyol in Component B comprises a polyol selected from poly(C₂₋₄-alkylene oxide)-based polyols, particularly poly(ethylene oxide)-based, poly(propylene oxide)-based, poly(butylene oxide)-based polyols, and mixtures of these.
56. Any one preceding embodiment, wherein the at least one polyol in Component B comprises a polyol selected from poly(propylene oxide)-based polyols.
57. Any one preceding embodiment, wherein the at least one polyol in Component B comprises a triol.
58. Any one preceding embodiment, wherein the at least one polyol in Component B comprises a triol selected from poly(C₂₋₄-alkylene oxide)-based, in particular poly(propylene oxide)-based, or castor oil.
59. Any one preceding embodiment, wherein the at least one polyol in Component B comprises castor oil.
60. Any one preceding embodiment, wherein the at least one polyol in Component B comprises a mixture of a polyether polyol and castor oil, in particular a mixture of polyether polyol having functionality of greater than 3, more preferably greater than 4, particularly preferably greater than 5, and castor oil.
61. Embodiment 60, wherein the polyether polyol having a functionality of greater than 3, more preferably greater than 4, particularly preferably greater than 5, is a poly(propylene oxide) polyol.
62. Any one preceding embodiment, wherein Component B comprises 40-60 wt % of a triol, based on the total weight of Component B.
63. Any one preceding embodiment, wherein Component B comprises 0-10 wt % of a polyol having functionality of greater than 3, more preferably greater than 4.
64. Any one preceding embodiment, wherein Component B comprises 0-20 wt % of a polyol having functionality greater than 2, more preferably a functionality of 3, and a molecular weight of less than 500 Da, more preferably less than 400 Da.
65. Any one preceding embodiment, wherein Component B comprises 40-60 wt % of a triol, based on the total weight of Component B, 0-10 wt % of a polyol having functionality of greater than 3, more preferably greater than 4, and 0-20 wt % of a polyol having functionality greater than 2, more preferably a functionality of 3, and a molecular weight of less than 500 Da, more preferably less than 400 Da.
66. Any one preceding embodiment, wherein the at least one polyol in Component B comprises a mixture of 80-97 wt %, more preferably 85-95 wt %, particularly preferably 91-94 wt % of castor oil, with 3-20 wt %, more preferably 5-15 wt %, particularly preferably 6-9 wt %, of a polyether polyol, in particular a polyether polyol having functionality of greater than 3, more preferably greater than 4, particularly preferably greater than 5, wherein the wt %'s are based on the total weight of polyols in Component B.
67. Any one preceding embodiment, wherein the at least one polyol in Component B comprises a mixture of 80-97 wt %, more preferably 85-95 wt %, particularly preferably 91-94 wt % of a triol, with 3-20 wt %, more preferably 5-15 wt %, particularly preferably 6-9 wt %, based on the total weight of polyols in Component B, of a polyether polyol having functionality of greater than 3, more preferably greater than 4, particularly preferably greater than 5.
68. Any one preceding embodiment, wherein the at least one polyol in Component B comprises a mixture of a poly(propylene oxide) having a functionality of 6 with castor oil.
69. Any one preceding embodiment, wherein the at least one polyol in Component B comprises a mixture of 80-97 wt %, more preferably 85-95 wt %, particularly preferably 91-94 wt % of castor oil, with 3-20 wt %, more preferably 5-15 wt %, particularly preferably 6-9 wt %, of a poly(propylene oxide) polyol having functionality of 6, wherein the wt %'s are based on the total weight of polyols in Component B.
70. Any one preceding embodiment, wherein Component B additionally comprises a catalyst that is capable of catalyzing the reaction of isocyanate groups with OH groups.
71. Any one preceding embodiment, wherein the catalyst is dioctyltin mercaptide.
72. Any one preceding embodiment, wherein the catalyst is used at 0.0005 to 0.002 wt %, more preferably 0.00075 to 0.0015 wt %, based on the total weight of Component B.
73. Any one preceding embodiment, wherein the catalyst is dioctyl tin mercaptide, used at 0.0005 to 0.002 wt %, more preferably 0.00075 to 0.0015 wt %, based on the total weight of Component B.
74. Any one preceding embodiment, wherein Component B additionally comprises talc.
75. Any one preceding embodiment, wherein Component B additionally comprises talc at 20-50 wt %, more preferably 30-40 wt %, particularly preferably 30-34 wt %, based on the total weight of Component B.
76. Any one preceding embodiment, wherein the substrates include metals and plastics.
77. Any one preceding embodiment, wherein the substrates are selected from e-coated steel, PET films, Aluminized plastic films, and Aluminium.
78. Any one preceding embodiment, wherein the cured adhesives of the invention (preferably a 1:1 volumetric ratio of Component A to Component B, curing: 7 days, 23° C., 50% RH) show a lap shear strength of 4 MPa or greater, when measured according to DIN EN 1465, with a bonded area: 250 mm² (10×25 mm), adhesive layer thickness of 1 mm, using e-coated steel for both substrates.
79. Any one preceding embodiment, wherein the adhesive mixture resulting from mixing Component A and Component B (preferably in a 0.8:1 to 1.2:1, more preferably 1:1 volumetric ratio) has a working time of greater than 60 minutes, more preferably greater than 65 minutes.
80. Any one preceding embodiment, wherein the adhesive mixture resulting from mixing Component A and Component B (preferably in a 0.8:1 to 1.2:1, more preferably 1:1 volumetric ratio) has a tensile strength of 5 MPa or less, after curing for seven days at 23° C. and 50% RH, when measured according to DIN EN ISO 527-2, and pulling the samples at 50 mm/min.
81. Any one preceding embodiment, wherein the adhesive mixture resulting from mixing Component A and Component B (preferably in a 0.8:1 to 1.2:1, more preferably 1:1 volumetric ratio) has an E-modulus of 15 or less, after curing for seven days at 23° C. and 50% RH, when measured according to DIN EN ISO 527-2, and pulling the samples at 50 mm/min.
82. Any one preceding embodiment, wherein the adhesive mixture resulting from mixing Component A and Component B (preferably in a 0.8:1 to 1.2:1, more preferably 1:1 volumetric ratio) has an elongation at break of 100% or more, after curing for seven days at 23° C. and 50% RH, when measured according to DIN EN ISO 527-2, and pulling the samples at 50 mm/min.

### EXAMPLES

TABLE 1
List of ingredients used in the Examples

| Trademark or | |
|---|---|
| abbreviation | Chemistry |
| WANNATE MDI-50 | mixture of 4,4′-diphenylmethane diisocyanate (50 wt %) and 2,4- |
| | diphenylmethane diisocyanate (50 wt %), functionality of 2 |
| WANNATE PM-200 | Polymeric MDI with a functionality of 2.6-2.7 |
| NJ-330 | polypropylene glycol |
| | Mn = 3000 Da, Functionality = 3 |
| NJ-305 | polypropylene glycol |
| | Mn = 500 Da, Functionality = 3 |
| DONOL R6049 | polypropylene glycol |
| | Mn = 680 Da, Functionality = 6 |
| Castor oil | Trifunctional polyol, with nominal molecular weight of |
| | 930.4 Da (triester of glycerol and ricinoleic acid) |
| Fomrez UL-29 | dioctyltin mercaptide catalyst |
| JSLD43105 | inactive red colour with diisononyl phthalate as solvent |
| Talc | Talc |
| CAB-O-SIL TS-720 | Fumed silica |
| Purmol 4st | Molecular sieves |

### Formulation of Adhesives

### Component a (Isocyanate)

### Prepolymer Preparation

The prepolymers were prepared in a 2 l four-necked flask equipped with a mechanical stirring bar and a thermometer. The isocyanate-terminated prepolymer was prepared by first mixing the polyol ingredient(s) of Component A, and stirring under reduced pressure at 120° C. for 1 hour. The polyol was allowed to cool to 80° C., the isocyanate ingredient was added, and the mixture was allowed to react under reduced pressure at 80° C. for 2 hours. The material was then cooled to less than 30° C. The vacuum was broken under nitrogen, and the prepolymers were stored hermetically until use.

A specific description of the prepolymer process is provided for Inventive Example 6. 568 g of NJ-330 was added into a four-necked flask equipped with a mechanical stirring bar and thermometer at room temperature. The NJ-300 was dried under reduced pressure at 120° C. for 1 hour. The NJ-300 was allowed to cool to 80° C., 712 g of MDI-50 was added into the flask, and the mixture was allowed to react under reduced pressure at 80° C. for 2 hours. The material was cooled to less than 30° C. The vacuum was broken under nitrogen, and the prepolymer was stored hermetically until use. The prepolymer is prepared with an excess of isocyanate, resulting in predominantly NCO-terminated prepolymer.

To prepare Component A, using the quantities listed in Table 2, the talc and fumed silica were dried at 120° C. in an oven for 24 hours or longer until the moisture content was less than 300 ppm. The prepolymer, was added into a 2 l planetary mixer and mixed together for 10 minutes. The dried talc and silica were added, and stirring was continued for a further 30 minutes at room temperature. The vacuum was then broken under nitrogen, and Component A was packaged in hermetic cartridges for storage until use.

A specific description of the preparation of Component A is provided for Inventive Example 6. The solids talc and CAB-O-SIL TS-720 were dried in 120° C. oven for at least 24 hours until the moisture content was less than 300 ppm. 640 g of prepolymer, 345 g of talc and 15 g of CAB-O-SIL were added into a 2 l planetary mixer, with the red colour. After 30 minutes of mixing at room temperature, the vacuum is broken with nitrogen and the adhesive component can be filled in suitable packaging size.

### Component B (Polyol)

To prepare Component B (polyol), using the quantities listed in Table 2, the talc and CAB-O-SIL TS-720 were dried at 120° C. in an oven for 24 hours or longer until the moisture content was less than 300 ppm. The polyols were dried using molecular sieves until the moisture content was less than 300 ppm. The dry ingredients were mixed with the polyols and stirring was continued for 30 minutes. The molecular sieves and Fomrez UL-29 were added and stirring was continued for an additional 30 minutes. The vacuum was broken under nitrogen, and Component B was filled in hermetic cartridges until use.

Components A and B were stored separately until use. Immediately before use, the components were mixed in a 1:1 volumetric ratio, and the following test were carried out.

### Working Time

Working time is the time for rheological viscosity to reach 900 Pas at 0.25/s shear rate, 500 Pas at 1/s shear rate, and 300 Pas at 2.5/s shear rate, concurrently. The results are listed in Table 2.

### Rheological Viscosity

Rheologic viscosity is measured using a TA Rheometer, with 25 mm parallel plates and a 0.2 mm gap, at 60 minutes after mixing Component A and Component B.

The results are listed in Table 2.

### Lap Shear Strength

Lap shear strength was measured using DIN EN 1465, with a bonded area: 250 mm² (10×25 mm), adhesive layer thickness of 1 mm, using e-coated steel for both substrates. All surfaces were prepared by cleaning with isopropanol prior to application of the adhesive. The curing conditions were 7 days at 23° C. at 50% RH. Shear samples were pulled at 5 mm/min during the tests. The results are listed in Table 2.

### Tensile Properties

Tensile strength, E-modulus, and elongation, were measured according to DIN EN ISO 527-2; curing condition: 7 days at 23° C., 50% RH; tensile samples were pulled at 50 mm/min in the process of testing. The results are listed in Table 2.

TABLE 2
Composition of Comparative Examples (CE) and Inventive Examplels (IE)
in wt % and characteristics

| | CE1 | CE2 | CE3 | | CE4 | | CE5 | | IE6 | |
|---|---|---|---|---|---|---|---|---|---|---|
| Component A | | | | | | | | | | |
| WANNATE FM-200 | 49.7 | 49.7 | — | | — | | — | | — | |
| WANNATE MOI-50 | | | 54 | | 50 | | 50 | | 35.6 | |
| NJ-330 | 14.3 | 14.3 | 5 | | 11 | | 11 | | 28.4 | |
| NJ-305 | | | 5 | | 3 | | 3 | | | |
| Talc | 34.5 | 34.5 | 34.5 | | 34.5 | | 34.5 | | 34.5 | |
| CAB-O-SIL TS-720 | 1.5 | 1.5 | 1.5 | | 1.5 | | 1.5 | | 1.5 | |
| Component B | | | | | | | | | | |
| JSLD43105 | 0.1 | 0.1 | 0.1 | | 0.1 | | 0.1 | | 0.1 | |
| NJ-330 | 17 | 17 | 17 | | 17 | | 14 | | | |
| Castor oil | 42 | 42 | 42 | | 42 | | 45 | | 59 | |
| Donol RS049 | 4 | 4 | 4 | | 4 | | 4 | | 4 | |
| Talc | 32.38 | 32.38 | 32.38 | | 32.38 | | 32.38 | | 32.38 | |
| CAB-O-SIL TS-720 | 1.5 | 1.5 | 1.5 | | 1.5 | | 1.5 | | 1.5 | |
| Purmol 4st | 3 | 3 | 3 | | 3 | | 3 | | 3 | |
| Fomrez UL-29 | 0.001 | 0 | 0.001 | | 0.001 | | 0.001 | | 0.001 | |
| Data | | | | | | | | | | |
| Working time (min.) | — | — | 45-60 | | 45-60 | | 45-60 | | >60 | |
| Rheologic viscosity | — | — | 1.290 | (0.25 s⁻¹) | 1.034 | (0.25 s⁻¹) | 957 | (0.25 s⁻¹) | 747 | (0.25 s⁻¹) |
| (Pas) for A + B | | | 436 | (1 s⁻¹) | 391 | (1 s⁻¹) | 363 | (1 s⁻¹) | 255 | (1 s⁻¹) |
| 25 mm parallel plate, | | | 246 | (2.5 s⁻¹) | 218 | (2.5 s⁻¹) | 200 | (2.5 s⁻¹) | 143 | (2.5 s⁻¹) |

| | | | | | | |
|---|---|---|---|---|---|---|
| 0.2 mm gap 60 | | | | | | |
| minutes after | | | | | | |
| Lap shear | >12 | >12 | >8 | >8 | >5 | >5 |
| strength (MPa) | | | | | | |
| Tensile | 15 | 15 | 12 | 10 | 3 | 6 |
| strength (MPa) | | | | | | |
| E-modulus (MPa) | 300 | 300 | 250 | 100 | 25 | 10 |
| Elongation at | 50 | 50 | 55 | 80 | 100 | 120 |
| break (%) | | | | | | |

### Results

Inventive Example 6 shows a working time of greater than 60 minutes, whereas the Comparative Examples show working times of less than 60 minutes.

Inventive Example 6 shows slower increase of viscosity than the Comparative Examples.

Inventive Example 6 shows more elasticity (lower E-modulus, higher elongation at break) than the Comparative Examples.

1. A two-component thermally-conductive polyurethane adhesive, comprising:
(A) Component A:
(ai) an NCO-terminated prepolymer made by reacting at least one polyol of molecular weight (Mn) greater than 2,000 Da and an OH functionality of 2-3, with 30-45 wt %, based on the total weight of Component A, of at least one polyisocyanate selected from aliphatic polyisocyanates and mixtures of 2,4′-methylene-bis-(phenyl isocyanate) (MDI) and 4,4′-MDI;
(B) Component B:
(bi) at least one polyol of molecular weight (Mn) of less than 1,000 Da and an OH functionality of at least 2; and
(bii) optionally a catalyst capable of catalyzing the reaction of OH groups with NCO groups.

4. 4 (canceled)

5. The adhesive of claim 1, wherein the polyol used to make the prepolymer is selected from polyether polyols.

6. The adhesive of claim 5, wherein the polyol used to make the prepolymer is selected from poly(propylene oxide) polyols.

7. The adhesive of claim 1, wherein the polyol used to make the prepolymer has a functionality of 2.5-3.

8. The adhesive of claim 7, wherein the polyol used to make the prepolymer is a poly(C₂₋₄ alkylene oxide) polyol having a functionality of 2.5-3.

9. The adhesive of claim 7, wherein the polyol used to make the prepolymer is a poly(propylene oxide) polyol having a functionality of 2.5-3.

10. The adhesive of claim 1, wherein the polyol used to make the prepolymer has a molecular weight (Mn) greater than 2,500 Da.

11. The adhesive of claim 1, wherein the polyisocyanate is a mixture of 2,4′-MDI and 4,4′-MDI.

12. The adhesive of claim 11, wherein the polyisocyanate is a mixture of 2,4′-MDI and 4,4′-MDI, and the weight ratio of 2,4′-MDI to 4,4′-MDI is 0.667-1.5.

13. The adhesive of claim 1, wherein the at least one polyol is used in Component A at 10-40 wt %, based on the total weight of Component A.

14. The adhesive of claim 1, wherein the at least one polyisocyanate is used in Component A at 20-50 wt %, based on the total weight of Component A.

15. The adhesive of claim 1, wherein the at least one polyol in Component B comprises polyols having molecular weights (Mn) greater than 400 Da.

16. The adhesive of claim 15, wherein the at least one polyol in Component B comprises polyols having molecular weights (Mn) of 400-1,000 Da.

17. The adhesive of claim 15, wherein the at least one polyol in Component B comprises polyols having a functionality of 3 or more.

18. The adhesive of claim 5, wherein the at least one polyol in Component B comprises a mixture of polyols with at least one polyol having a functionality of 3 and with at least one another polyol having a functionality of greater than 3.

19. The adhesive of claim 5, wherein the at least one polyol in Component B comprises a triol selected from poly(C₂₋₄-alkylene oxide)-based triol, or castor oil.

20. The adhesive of claim 5, wherein the at least one polyol in Component B comprises a mixture of a polyether polyol having functionality of greater than 3 and castor oil.
